(19) United States
(12) Patent Application Publication
(10) Pub. No.: US 2026/0348129 A1
(43) Pub. Date: Nov. 5, 2026

(54) Work Machine

(71) Applicant: Hitachi Construction Machinery Co., Ltd., Taito-ku, Tokyo (JP)

(72) Inventors: Masahiro KAYANE, Tsuchiura-shi (JP); Mitsuhiko KANEHAMA, Tsuchiura-shi (JP)

(21) Appl. No.: 19/101,935

(22) PCT Filed: Sep. 27, 2023
(86) PCT No.: PCT/JP2023/035296

§ 371 Date: Feb. 7, 2025

(30) Foreign Application Priority Data
Sep. 29, 2022 (JP) 2022-157181

(51) Int. Cl. E02F 9/22; E02F 3/42; E02F 3/43; F15B 13/02; F15B 15/18; F15B 19/00

(52) U.S. Cl. CPC E02F 9/2203; E02F 9/2217; E02F 9/226; E02F 9/2282; E02F 9/2285; F15B 13/025; F15B 13/027; F15B 15/18; F15B 19/00; E02F 3/425; E02F 3/435; E02F 9/2296

(57) ABSTRACT

A work machine includes: a cylinder control valve that controls a flow of a hydraulic operating fluid from a hydraulic pump to a hydraulic cylinder; a first pressure reducing valve that reduces the pressure of the hydraulic operating fluid delivered from the hydraulic pump to generate a pilot primary pressure; a second pressure reducing valve that generates a secondary pressure acting on a pressure receiving section of the cylinder control valve; a bypass cut valve; a third pressure reducing valve that generates a secondary pressure acting on a pressure receiving section of the bypass cut valve; a regeneration passage that connects a meter-in passage and a meter-out passage to each other; a meter-out restrictor; and a controller. The controller controls the third pressure reducing valve such that the opening area of the bypass cut valve becomes smaller, when the pressure of the hydraulic pump sensed by the pressure sensor becomes lower, and reduces the opening area of the meter-out restrictor as the operation amount of an operation of operating a work device in the gravity direction becomes larger.

### TECHNICAL FIELD

The present invention relates to a work machine.

### BACKGROUND ART

A work machine is known that includes a main circuit for controlling, by a cylinder control valve, a hydraulic operating fluid delivered from a hydraulic pump and supplying it to a hydraulic cylinder, and a pilot circuit for reducing, by a pilot pressure reducing valve, the pressure of a part of the hydraulic operating fluid delivered from the hydraulic pump, supplying it to a solenoid proportional pressure reducing valve as a pilot primary pressure, and introducing a secondary pressure generated by the solenoid proportional pressure reducing valve to the cylinder control (see Patent Document 1). In the work machine described in Patent Document 1, a bypass sequence valve is provided in a bypass passage connecting the hydraulic pump and a tank to each other. The bypass sequence valve is controlled to be in a communication state when there is no manual operation signal from an operation device, and when there is a manual operation signal from the operation device, the pressure at the inlet of the bypass sequence valve (that is, the delivery pressure of the hydraulic pump) is controlled such that the pressure is equal to or higher than the pilot primary pressure.

### PRIOR ART DOCUMENT

### Patent Document

Patent Document 1: JP-2001-263304-A

### SUMMARY OF THE INVENTION

### Problem to Be Solved by the Invention

In a work machine provided with a work device having a boom, an arm, and a bucket, in a case where such an operation as a boom lowering operation in a state where the bucket is positioned in the air or an arm crowding operation for pulling the work device toward the front side from a state in which the work device is extended, which operation causes the work device to operate in a direction in which the gravity acts on the work device (hereinafter, the gravity direction), is performed, the delivery pressure of the hydraulic pump is lowered. In the technique described in Patent Document 1, the bypass sequence valve is controlled such that the delivery pressure of the hydraulic pump is equal to or higher than the pilot primary pressure as described above.

However, in a case where the weight and the position of the center of gravity of the work device are changed by, for example, replacing the bucket attached to the tip end of the work device with a heavier one and the moment of inertia of the work device increases, when an operation of causing the work device to operate in the gravity direction is performed, there is a risk that the delivery pressure of the hydraulic pump becomes lower than the pilot primary pressure only by controlling the bypass sequence valve. That is, in the technique described in Patent Document 1, it may be difficult to secure a stable pilot primary pressure if the specifications of the work device are changed.

An object of the present invention is to provide a work machine capable of securing a stable pilot primary pressure in a case where an operation of causing a work device to operate in the gravity direction is performed.

### Means for Solving the Problem

A work machine according to one aspect of the present invention includes: a work device that has a plurality of hydraulic cylinders and a plurality of members to be driven by the plurality of hydraulic cylinders; an operation device for operating the hydraulic cylinders; a main circuit that supplies a hydraulic operating fluid delivered from a hydraulic pump to the hydraulic cylinders; a cylinder control valve that is provided in the main circuit and controls a flow of the hydraulic operating fluid supplied from the hydraulic pump to the hydraulic cylinders; a pilot circuit that introduces a part of the hydraulic operating fluid delivered from the hydraulic pump to a pilot pressure receiving section of the cylinder control valve; a first pressure reducing valve that is provided in the pilot circuit and reduces a pressure of the hydraulic operating fluid delivered from the hydraulic pump to generate a pilot primary pressure; a second pressure reducing valve that is provided in the pilot circuit and reduces the pilot primary pressure to generate a pilot secondary pressure acting on the pilot pressure receiving section of the cylinder control valve; a center bypass passage that connects the hydraulic pump and a tank to each other and is provided with the cylinder control valve; a bypass cut valve that is provided in the center bypass passage; a third pressure reducing valve that is provided in the pilot circuit and reduces the pilot primary pressure to generate a pilot secondary pressure acting on a pilot pressure receiving section of the bypass cut valve; a regeneration passage that connects a meter-in passage for introducing the hydraulic operating fluid delivered from the hydraulic pump to the hydraulic cylinders and a meter-out passage for introducing return oil from the hydraulic cylinders to the tank to each other; a check valve that is provided in the regeneration passage, permits a flow of the hydraulic operating fluid from the meter-out passage to the meter-in passage, and prohibits a flow of the hydraulic operating fluid from the meter-in passage to the meter-out passage; a meter-out restrictor that is provided in the meter-out passage; a pressure sensor that senses the pressure of the hydraulic operating fluid on a delivery side of the hydraulic pump; and a controller that controls the second pressure reducing valve on the basis of an operation amount of the operation device. The controller controls the third pressure reducing valve on the basis of the pressure sensed by the pressure sensor, controls the third pressure reducing valve such that an opening area of the bypass cut valve becomes small, when the pressure sensed by the pressure sensor becomes low, and is configured to reduce an opening area of the meter-out restrictor as the operation amount of an operation of causing the work device to operate in a gravity direction by the operation device becomes larger.

### Advantages of the Invention

According to the present invention, it is possible to secure a stable pilot primary pressure when an operation of causing a work device to operate in the gravity direction is performed.

### BRIEF DESCRIPTION OF THE DRAWINGS

FIG. 1 is a side view of a hydraulic excavator according to a first embodiment of the present invention.

FIG. 2 is a diagram for depicting a hydraulic system mounted on the hydraulic excavator according to the first embodiment of the present invention.

FIG. 3 is a flowchart for depicting an example of a flow of processing of valve control executed by a main controller according to the first embodiment of the present invention.

FIG. 4 is a diagram for depicting time-series changes in the operation position of a gate lock lever device, the boom lowering operation amount of a boom operation device, the delivery pressure of a hydraulic pump, the delivery capacity of the hydraulic pump, the opening area of a bypass cut valve, and the opening area of a meter-out restrictor of a CT opening control valve.

FIG. 5 is a functional block diagram of a main controller according to a second embodiment of the present invention and depicts a function related to control of the bypass cut valve.

FIG. 6 is a diagram for depicting a hydraulic system according to a modified example of the embodiment of the present invention.

### MODES FOR CARRYING OUT THE INVENTION

A work machine according to embodiments of the present invention will be described with reference to the drawings. In the present embodiments, an example in which the work machine is a crawler type hydraulic excavator will be described.

### First Embodiment

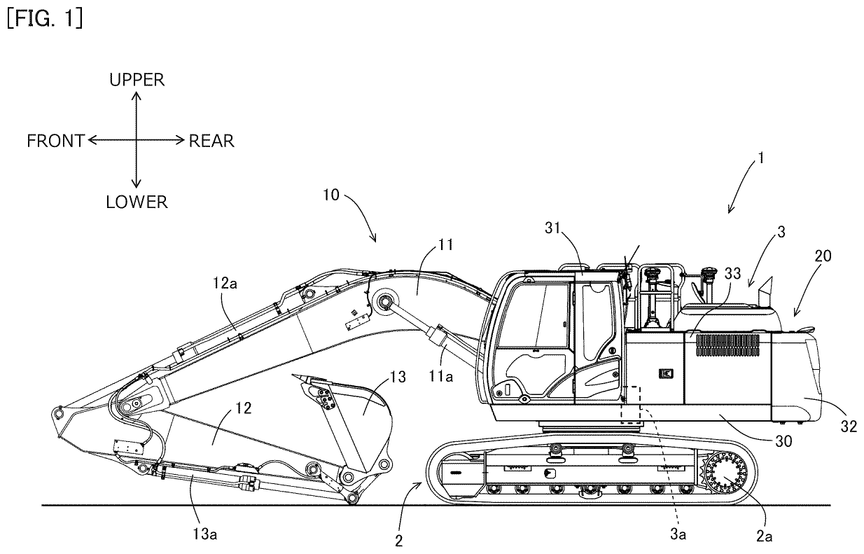

FIG. 1 is a side view of a hydraulic excavator 1 according to a first embodiment of the present invention. For convenience of explanation, the longitudinal and vertical directions of the hydraulic excavator 1 are defined as depicted in FIG. 1. In the present embodiment, unless otherwise noted, the front of the driver seat (the left direction in the drawing) is assumed to be the front of the hydraulic excavator 1.

The hydraulic excavator 1 includes a machine body (vehicle body) 20 and a work device 10 attached to the machine body 20. The machine body 20 includes a track structure 2 and a swing structure 3 swingably mounted on the track structure 2. The track structure 2 has a pair of left and right crawlers and a travelling hydraulic motor 2a that is an actuator. The track structure 2 travels by the crawlers being driven by the travelling hydraulic motor 2a. The swing structure 3 has a swing frame 30, a swinging hydraulic motor 3a that is an actuator, and a deceleration mechanism for decelerating the revolution of the swinging hydraulic motor 3a to be transmitted to the swing frame 30. The swing structure 3 rotates relative to the track structure 2 by the swinging hydraulic motor 3a.

The swing structure 3 has an operation room 31 provided on the front left side of the swing frame 30, a counter weight 32 provided at the rear of the swing frame 30, and an engine room 33 provided on the rear side of the operation room 31 in the swing frame 30. The engine room 33 houses an engine that is a prime mover and hydraulic equipment such as a hydraulic pump, a valve, and an accumulator. The work device 10 is rotatably coupled to the front center of the swing frame 30.

The work device 10 is an articulated work device having a plurality of rotatably-coupled members to be driven and a plurality of hydraulic cylinders for driving the members to be driven. In the present embodiment, a boom 11, an arm 12, and a bucket 13 as three members to be driven are coupled in series. The proximal end of the boom 11 is rotatably coupled to the front of the swing frame 30. The proximal end of the arm 12 is rotatably coupled to the distal end of the boom 11. The bucket 13 is rotatably coupled to the distal end of the arm 12.

The boom 11 is driven by a hydraulic cylinder (hereinafter, also referred to as a boom cylinder 11a) that is an actuator, and rotates relative to the swing frame 30. The arm 12 is driven by a hydraulic cylinder (hereinafter, also referred to as an arm cylinder 12a) that is an actuator, and rotates relative to the boom 11. The bucket 13 is driven by a hydraulic cylinder (hereinafter, also referred to as a bucket cylinder 13a) that is an actuator, and rotates relative to the arm 12.

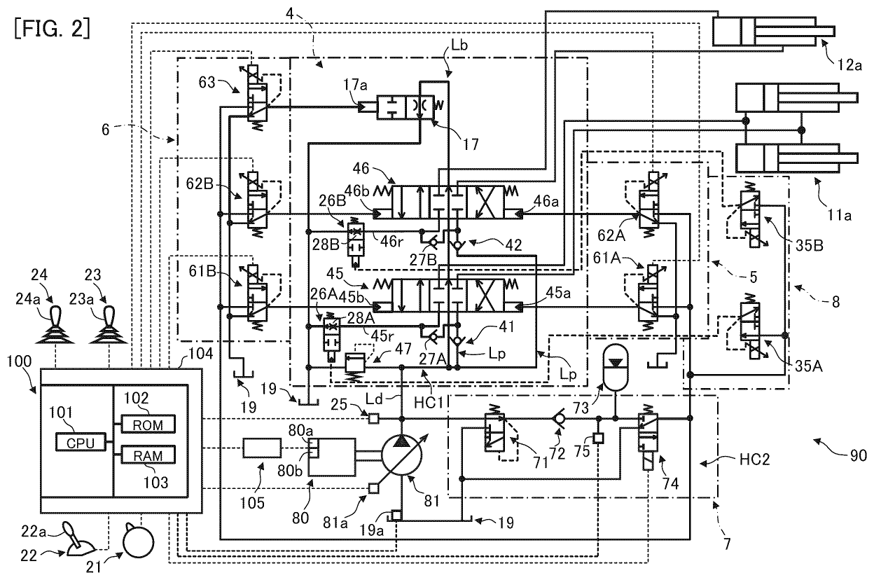

FIG. 2 is a diagram for depicting a hydraulic system 90 mounted on the hydraulic excavator 1. It should be noted that although the hydraulic system 90 is provided with hydraulic equipment for driving the plurality of hydraulic actuators (2a, 3a, 11a, 12a, and 13a), only the hydraulic equipment for driving the boom cylinder 11a and the arm cylinder 12a is illustrated in FIG. 2, and illustration of the hydraulic equipment for driving other hydraulic actuators (2a, 3a, and 13a) is omitted. In addition, although a plurality of hydraulic pumps 81 is often used to drive the actuators, the following description will take as an example a case where one hydraulic pump 81 is used to drive the actuators.

FIG. 2 also illustrates a main controller 100 that is a controller for controlling the hydraulic system 90, and a device for outputting signals to the main controller 100. As depicted in FIG. 2, the hydraulic excavator 1 includes an engine control dial 21 for setting a target revolution speed of the engine 80, an operation device 23 for operating the boom cylinder 11a (boom 11) (also referred to as a boom operation device), an operation device 24 for operating the arm cylinder 12a (arm 12) (also referred to as an arm operation device), and a gate lock lever device 22. These devices (21 to 24) are provided in the operation room 31.

The boom operation device 23 has an operation lever 23a that can be tilted from the neutral position to the boom raising side and the boom lowering side, and an operation sensor that senses the operation direction and the operation amount of the operation lever 23a and outputs an operation signal indicating the operation direction and the operation amount of the operation lever 23a to the main controller 100. The arm operation device 24 has an operation lever 24a that can be tilted from the neutral position to the arm crowding side and the arm dumping side, and an operation sensor that senses the operation direction and the operation amount of the operation lever 24a and outputs an operation signal indicating the operation direction and the operation amount of the operation lever 24a to the main controller 100. The operation amounts (operation angles) of the operation levers 23a and 24a sensed by the operation sensors of the operation devices 23 and 24 are 0 [%] (0°) in the neutral positions, and the absolute values thereof become large as the levers are tilted from the neutral positions.

The gate lock lever device 22 has a lever 22a that is selectively operated between a lock position (raised position) that permits entry into and exit from the operation room 31 and prohibits the operation of the actuators (11a, 12a, and 13a), and a lock release position (lowered position) that prohibits entry into and exit from the operation room 31 and permits the operation of the actuators (11a, 12a, and 13a). In addition, the gate lock lever device 22 has an operation position sensor that senses the operation position of the lever 22a and outputs a gate lock lever signal indicating the operation position of the lever 22a to the main controller 100.

The engine control dial 21 is an operation device for setting the target revolution speed of the engine 80, and outputs an operation signal to the main controller 100. The main controller 100 decides the target revolution speed on the basis of the operation signal from the engine control dial 21, and outputs a signal of the target revolution speed to an engine controller 105. The engine 80 is provided with a revolution speed sensor 80a for sensing the actual revolution speed of the engine 80 and a fuel injection device 80b for adjusting the injection amount of fuel injected into the cylinder of the engine 80. The engine controller 105 controls the fuel injection device 80b such that the actual revolution speed of the engine 80 sensed by the revolution speed sensor 80a becomes the target revolution speed output from the main controller 100.

The hydraulic system 90 includes the hydraulic pump 81, a main circuit HC1 for supplying a hydraulic operating fluid as an operating fluid delivered from the hydraulic pump 81 to the boom cylinder 11a and the arm cylinder 12a, a pilot circuit HC2 connected to the main circuit HC1, and a center bypass passage Lb for connecting the hydraulic pump 81 and a tank 19 for storing the hydraulic operating fluid to each other. The pilot circuit HC2 is a circuit for introducing a part of the hydraulic operating fluid delivered from the hydraulic pump 81 to pilot pressure receiving sections 45a, 45b, 46a, and 46b of cylinder control valves 45 and 46 to be described later, a pilot pressure receiving section 17a of a bypass cut valve 17 to be described later, and pilot pressure receiving sections of CT opening control valves 26A and 26B to be described later.

The hydraulic pump 81 is connected to the engine 80 and driven by the engine 80 to suck in the hydraulic operating fluid from the tank 19 and deliver it. The hydraulic pump 81 is a variable capacity piston-type hydraulic pump, and the delivery capacity (displacement volume) is changed by changing the tilting angle of a swash plate by a regulator 81a. The regulator 81a has a tilting actuator for controlling the tilting angle of the swash plate of the hydraulic pump 81, and a solenoid proportional valve for generating the control pressure the tilting actuator by using the delivery pressure of the hydraulic pump 81 as the original pressure. The engine 80 is a power source of the hydraulic excavator 1 and is configured with, for example, an internal combustion engine such as a diesel engine.

The main circuit HC1 is provided with a cylinder control valve 45 for controlling the flow (flow rate and direction) of the hydraulic operating fluid supplied from the hydraulic pump 81 to the boom cylinder 11a (hereinafter, also referred to as a boom control valve), and a cylinder control valve 46 for controlling the flow (flow rate and direction) of the hydraulic operating fluid supplied from the hydraulic pump 81 to the arm cylinder 12a (hereinafter, also referred to as an arm control valve).

The main circuit HC1 is provided with a relief valve 47 for defining the maximum pressure of the delivery pressure of the hydraulic pump 81 by discharging the hydraulic operating fluid delivered from the hydraulic pump 81 to the tank 19 when the delivery pressure of the hydraulic pump 81 (circuit pressure) exceeds a preset setting pressure.

The main circuit HC1 has a pump delivery passage Ld connected to a delivery port of the hydraulic pump 81, and a parallel passage Lp connected to the pump delivery passage Ld.

The parallel passage Lp is a passage for introducing the hydraulic operating fluid from the pump delivery passage Ld to pump ports of the boom control valve 45 and the arm control valve 46. That is, the parallel passage Lp configures a part of a meter-in passage that introduces the hydraulic operating fluid delivered from the hydraulic pump 81 to the hydraulic cylinder. A check valve 41 for holding the load pressure of the boom cylinder 11a is provided in the parallel passage Lp connected to the pump port of the boom control valve 45. The check valve 41 is fully closed when the pump delivery pressure falls below the cylinder pressure. A check valve 42 for holding the load pressure of the arm cylinder 12a is provided in the parallel passage Lp connected to the pump port of the arm control valve 46. The check valve 42 is fully closed when the pump delivery pressure falls below the cylinder pressure.

A tank port of the boom control valve 45 is connected to the tank 19 via a return oil line 45r. The return oil line 45r configures a part of a meter-out passage that introduces return oil from the boom cylinder 11a to the tank 19. A CT opening control valve (meter-out control valve) 26A is provided in the return oil line 45r. The CT opening control valve 26A has a meter-out restrictor 28A that imparts resistance to the flow of the hydraulic operating fluid that passes therethrough, and discharges the return oil from the boom cylinder 11a to the tank 19 through the meter-out restrictor 28A. The CT opening control valve 26A operates according to a pilot secondary pressure output from a solenoid valve 35A to be described later, and the opening area (opening degree) of the meter-out restrictor 28A changes. The return oil line (meter-out passage) 45r of the boom control valve 45 and the parallel passage (meter-in passage) Lp are connected to each other by a regeneration passage provided with a check valve 27A for regeneration. The check valve 27A is a check valve that permits a flow of the hydraulic operating fluid from the return oil line 45r to the parallel passage Lp and prohibits a flow of the hydraulic operating fluid from the parallel passage Lp to the return oil line 45r.

For example, in a state where the bucket 13 is not grounded to the ground surface and the work device 10 is held in the air, when a boom lowering operation is performed and the work device 10 descends, the rod pressure becomes low and the bottom pressure becomes high with the contraction of the boom cylinder 11a. The check valve 27A for regeneration opens when the bottom pressure exceeds the rod pressure. Accordingly, a part of the return oil from a bottom chamber is regenerated and supplied to a rod chamber through the check valve 27A, and the rest is returned to the tank 19 through the meter-out restrictor 28A of the CT opening control valve 26A. It should be noted that, when the rod pressure exceeds the bottom pressure by a boom lowering operation being performed in a state where the bucket 13 is grounded, by a jack-up operation in which the machine body 20 floats being performed by the work device 10, and the like, the check valve 27A for regeneration is fully closed.

A similar regeneration passage is also provided in the arm control valve 46. A tank port of the arm control valve 46 is connected to the tank 19 via a return oil line 46r. The return oil line 46r configures a part of the meter-out passage that introduces return oil from the arm cylinder 12a to the tank 19. The CT opening control valve (meter-out control valve) 26B is provided in the return oil line 46r. The CT opening control valve 26B has a meter-out restrictor 28B that imparts resistance to the flow of the hydraulic operating fluid that passes therethrough, and discharges the return oil from the arm cylinder 12a to the tank 19 through the meter-out restrictor 28B. The CT opening control valve 26B operates according to a pilot secondary pressure output from a solenoid valve 35B to be described later, and the opening area (opening degree) of the meter-out restrictor 28B changes.

The return oil line (meter-out passage) 46r of the arm control valve 46 and the parallel passage (meter-in passage) Lp are connected to each other by a regeneration passage provided with a check valve 27B for regeneration. The check valve 27B is a check valve that permits a flow of the hydraulic operating fluid from the return oil line 46r to the parallel passage Lp and prohibits a flow of the hydraulic operating fluid from the parallel passage Lp to the return oil line 46r. The check valve 27 for regeneration opens when the bottom pressure exceeds the rod pressure with the contraction of the arm cylinder 12a. Accordingly, a part of the return oil from the bottom chamber is regenerated and supplied to the rod chamber through the check valve 27B, and the rest is returned to the tank 19 through the meter-out restrictor 28B of the CT opening control valve 26B. It should be noted that, when the rod pressure exceeds the bottom pressure, the check valve 27B for regeneration is fully closed.

The center bypass passage Lb branches from the pump delivery passage Ld and is connected to the tank 19. In the center bypass passage Lb, the boom control valve 45, the arm control valve 46, and the bypass cut valve 17 are provided in tandem in this order from the upstream side to the downstream side thereof. The bypass cut valve 17 has a restrictor that imparts resistance to the flow of the hydraulic operating fluid that passes therethrough, and the hydraulic operating fluid delivered from the hydraulic pump 81 is discharged to the tank 19 through the restrictor. The bypass cut valve 17 can adjust the pump delivery pressure by changing the opening area (opening degree) of the restrictor.

The pilot circuit HC2 is provided with a pilot pressure reducing valve (first pressure reducing valve) 71 for reducing the pressure of the hydraulic operating fluid delivered from the hydraulic pump 81 (that is, the pump delivery pressure) to generate a pilot primary pressure, a check valve 72 for holding the pilot primary pressure, an accumulator 73 for smoothing the pilot primary pressure, and a lock valve 74 capable of interrupting the pilot primary pressure. In addition, the pilot circuit HC2 is provided with solenoid valves (second pressure reducing valves) 61A and 61B that reduce the pilot primary pressure to generate the pilot secondary pressure acting on the pilot pressure receiving sections 45a and 45b of the boom control valve 45, and solenoid valves (second pressure reducing valves) 62A and 62B that reduce the pilot primary pressure to generate the pilot secondary pressure acting on the pilot pressure receiving sections 46a and 46b of the arm control valve 46. In addition, the pilot circuit HC2 is provided with a solenoid valve (third pressure reducing valve) 63 for reducing the pilot primary pressure to generate the pilot secondary pressure acting on the pilot pressure receiving section 17a of the bypass cut valve 17.

Further, the pilot circuit HC2 is provided with a solenoid valve (fourth pressure reducing valve) 35A that reduces the pilot primary pressure to generate the pilot secondary pressure acting on the pilot pressure receiving section of the CT opening control valve 26A, and a solenoid valve (fourth pressure reducing valve) 35B that reduces the pilot primary pressure to generate the pilot secondary pressure acting on the pilot pressure receiving section of the CT opening control valve 26B. The solenoid valves 35A, 35B, 61A, 61B, 62A, 62B, and 63 are solenoid proportional valves driven by a solenoid thrust generated according to a control current supplied to the solenoid.

The solenoid valves 61A and 61B use the pilot primary pressure generated by the pilot pressure reducing valve 71 as the original pressure to generate the pilot secondary pressure to be output to the pilot pressure receiving sections 45a and 45b of the boom control valve 45. The solenoid valves 61A and 61B are controlled on the basis of a signal (control current) output from the main controller 100. The main controller 100 controls the solenoid valves 61A and 61B on the basis of an operation signal output from the boom operation device 23.

When the pilot secondary pressure generated by the solenoid valve 61A acts on the pilot pressure receiving section 45a of the boom control valve 45, the boom control valve 45 is switched to the extension position. Accordingly, the hydraulic operating fluid delivered from the hydraulic pump 81 is introduced to the bottom chamber of the boom cylinder 11a, the hydraulic operating fluid is discharged from the rod chamber to the tank 19, and the boom cylinder 11a is extended. As a result, the boom 11 rotates upward (that is, the boom 11 rises).

When the pilot secondary pressure generated by the solenoid valve 61B acts on the pilot pressure receiving section 45b of the boom control valve 45, the boom control valve 45 is switched to the contraction position. Accordingly, the hydraulic operating fluid delivered from the hydraulic pump 81 is introduced to the rod chamber of the boom cylinder 11a, the hydraulic operating fluid is discharged from the bottom chamber to the tank 19, and the boom cylinder 11a is contracted. As a result, the boom 11 rotates downward (that is, the boom 11 falls down).

The solenoid valves 62A and 62B use the pilot primary pressure generated by the pilot pressure reducing valve 71 as the original pressure to generate the pilot secondary pressure to be output to the pilot pressure receiving sections 46a and 46b of the arm control valve 46. The solenoid valves 62A and 62B are controlled on the basis of a signal (control current) output from the main controller 100. The main controller 100 controls the solenoid valves 62A and 62B on the basis of an operation signal output from the arm operation device 24.

When the pilot secondary pressure generated by the solenoid valve 62A acts on the pilot pressure receiving section 46a of the arm control valve 46, the arm control valve 46 is switched to the extension position. Accordingly, the hydraulic operating fluid delivered from the hydraulic pump 81 is introduced to the bottom chamber of the arm cylinder 12a, the hydraulic operating fluid is discharged from the rod chamber to the tank 19, and the arm cylinder 12a is extended. As a result, the arm 12 rotates downward (that is, the arm 12 performs a crowding operation).

When the pilot secondary pressure generated by the solenoid valve 62B acts on the pilot pressure receiving section 46b of the arm control valve 46, the arm control valve 46 is switched to the contraction position. Accordingly, the hydraulic operating fluid delivered from the hydraulic pump 81 is introduced to the rod chamber of the arm cylinder 12a, the hydraulic operating fluid is discharged from the bottom chamber to the tank 19, and the arm cylinder 12a is contracted. As a result, the arm 12 rotates upward (that is, the arm 12 performs a dumping operation).

The solenoid valve 63 uses the pilot primary pressure generated by the pilot pressure reducing valve 71 as the original pressure to generate the pilot secondary pressure to be output to the pilot pressure receiving section 17a of the bypass cut valve 17. The solenoid valve 63 is controlled on the basis of a signal (control current) output from the main controller 100. The main controller 100 controls the solenoid valve 63 on the basis of a gate lock lever signal output from the gate lock lever device 22, operation signals output from the operation devices 23 and 24, and a pressure sensed by a pressure sensor 25 to be described later.

The position of the spool of the bypass cut valve 17 is controlled according to the pilot secondary pressure acting on the pilot pressure receiving section 17a. Where the pilot secondary pressure is equivalent to the tank pressure, the spool is held in the neutral position by the spring force of a return spring. At this time, the opening area of the restrictor becomes a maximum opening area Abmax.

When the pilot secondary pressure acting on the pilot pressure receiving section 17a increases, the spool moves against the spring force of the return spring, and the opening area of the restrictor becomes small. When the pilot secondary pressure acting on the pilot pressure receiving section 17a further increases and the spool moves to the interruption position, communication between the hydraulic pump 81 and the tank 19 is interrupted by the bypass cut valve 17. At this time, the opening area of the restrictor becomes a minimum opening area Abmin (for example, 0).

A lock valve 74 is provided between the pilot pressure reducing valve 71 and the solenoid valves 35A, 35B, 61A, 61B, 62A, 62B, and 63. The lock valve 74 is a solenoid switching valve that is switched to either the interruption position or the communication position by a control signal output from the main controller 100 according to the operation position of the gate lock lever device 22.

When the gate lock lever device 22 is operated to the lock position, the lock valve 74 is switched to the interruption position. Accordingly, the pilot primary pressure to the solenoid valves 61A, 61B, 62A, and 62B is interrupted, and the operation by the operation levers 23a and 24a is disabled. In addition, since the pilot primary pressure to the solenoid valve 63 is also interrupted, the bypass cut valve 17 is held in the neutral position regardless of the operation by the operation devices 23 and 24.

When the gate lock lever device 22 is operated to the lock release position, the lock valve 74 is switched to the communication position. Therefore, in a state where the gate lock lever device 22 is operated to the lock release position, the pilot secondary pressure according to the operation directions and the operation amounts of the operation levers 23a and 24a is generated by the solenoid valves 61A, 61B, 62A, and 62B, and the actuators (11a and 12a) corresponding to the operated operation levers 23a and 24a are operated.

It should be noted that since the pilot circuit HC2 is provided with the check valve 72 and the accumulator 73 as described above, the pilot primary pressure can be maintained even where the delivery pressure of the hydraulic pump 81 temporarily becomes lower than the setting pressure of the pilot pressure reducing valve 71.

The main controller 100 is configured with a microcomputer including a CPU (Central Processing Unit) 101 as an operation circuit, a ROM (Read Only Memory) 102 as a storage device, a RAM (Random Access Memory) 103 as a storage device, an input/output interface 104, and other peripheral circuits. The main controller 100 may be configured with one microcomputer or a plurality of microcomputers. The engine controller 105 has a configuration similar to the main controller 100, is connected to the main controller 100, and exchanges information (data) with each other.

The ROM 102 is a nonvolatile memory such as an EEPROM and stores a program capable of executing various computations. That is, the ROM 102 is a storage medium that can read a program for realizing the function of the present embodiment. The RAM 103 is a volatile memory and is a work memory that directly inputs and outputs data to and from the CPU 101. The RAM103 temporarily stores necessary data while the CPU101 executes the computation of the program. It should be noted that the main controller 100 may further include a storage device such as a flash memory or a hard disk drive.

The CPU 101 is a processing device for developing a program stored in the ROM 102 into the RAM 103 and executing the computation, and performs predetermined computation processing on signals taken in from the input/output interface 104, the ROM 102, and the RAM 103 in accordance with the program. Signals from the engine control dial 21, the gate lock lever device 22, the operation devices 23 and 24, the pressure sensor 25, the engine controller 105, and the like are input to the input/output interface 104. An input section of the input/output interface 104 converts the input signal such that it can be computed by the CPU 101. In addition, an output section of the input/output interface 104 generates an output signal according to the computation result of the CPU 101, and outputs the signal to the lock valve 74, the solenoid valves 35A, 35B, 61A, 61B, 62A, 62B, and 63, the regulator 81a, and the like.

The pressure sensor 25 senses the pressure of the hydraulic operating fluid on the delivery side of the hydraulic pump 81. The pressure sensor 25 according to the present embodiment senses the delivery pressure of the hydraulic pump 81 (the circuit pressure of the main circuit HC1) and outputs a signal indicating the sensed result (the pump delivery pressure) to the main controller 100. The main controller 100 controls the delivery capacity of the hydraulic pump 81 by the regulator 81a on the basis of the pump delivery pressure and the actual engine revolution speed sensed by the sensors 25 and 80a and the operation signals from the operation device 23 and 24.

The hydraulic system 90 according to the present embodiment has a control valve block 4 having the boom control valve 45, the arm control valve 46, the bypass cut valve 17, the CT opening control valves 26A and 26B, the check valves 27A, 27B, 41, and 42, and the relief valve 47, a first solenoid valve block 5 having the solenoid valves 61A and 62A, a second solenoid valve block 6 having the solenoid valves 61B, 62B, and 63, a third solenoid valve block 8 having the solenoid valves 35A and 35B, and a pilot primary pressure generation block 7 having the pilot pressure reducing valve 71, the check valve 72, and the lock valve 74.

The control valve block 4 distributes the hydraulic operating fluid delivered from the hydraulic pump 81 to the hydraulic cylinders such as the boom cylinder 11a and the arm cylinder 12a. The pilot primary pressure generation block 7 reduces the pressure of the hydraulic operating fluid delivered from the hydraulic pump 81 to an appropriate setting pressure (for example, 4 MPa) by the pilot pressure reducing valve 71. When the lock valve 74 is switched to the communicating position, the pilot primary pressure generated by the pilot pressure reducing valve 71 is introduced to the first to third solenoid valve blocks 5, 6, and 8. When the lock valve 74 is switched to the interruption position, pilot primary pressure circuits of the first to third solenoid valve blocks 5, 6, and 8 are connected to the tank 19. Accordingly, since release is made until the primary pressures of the solenoid valves 35A, 35B, 61A, 61B, 62A, 62B, and 63 reach near 0 (zero), the respective valves 17, 26A, 26B, 45, and 46 are held in the neutral positions. It should be noted that since the pilot primary pressure generation block 7 includes the check valve 72 and the accumulator 73, the pilot primary pressure is temporarily maintained even where the pump delivery pressure becomes lower than the setting pressure of the pilot pressure reducing valve 71.

When such an operation as the boom lowering operation in a state where the bucket 13 is positioned in the air or the arm crowding operation to a direction in which the arm 12 is perpendicular to the ground, which operation causes the work device 10 to operate in a direction in which gravity acts (gravity direction), is performed, the pump delivery pressure is lowered. Where the pump delivery pressure is lowered, the main controller 100 raises the pump delivery pressure by reducing the opening area of the restrictor of the bypass cut valve 17 to secure the pilot primary pressure. Here, if the specification of the work device 10 becomes different from the standard specification due to replacement of the bucket 13 or the like, the weight of the work device 10 may increase or the position of the center of gravity of the work device 10 may become far from the center of swing. In this case, the moment of inertia of the work device 10 increases. Where an operation of causing the work device 10 to operate in the gravity direction is performed in a state where the moment of inertia increases more than in the standard specification, there is a risk that the pump delivery pressure becomes lower than the pilot primary pressure held by the check valve 72 only by controlling the bypass cut valve 17.

Thus, in the present embodiment, when an operation of operating the work device 10 in the gravity direction is performed, not only the bypass cut valve 17 is controlled but also the CT opening control valves 26A and 26B are controlled to reduce the openings of the meter-out restrictors 28A and 28B, thereby increasing the regeneration flow rate supplied to the hydraulic cylinders 11a and 12a. Accordingly, the hydraulic cylinders 11a and 12a can be driven at a speed according to the operation amount without consuming the pump delivery flow rate as much as possible, the delivery pressure of the hydraulic pump 81 is prevented from being lower than the setting pressure of the pilot pressure reducing valve 71, and the pilot primary pressure is maintained.

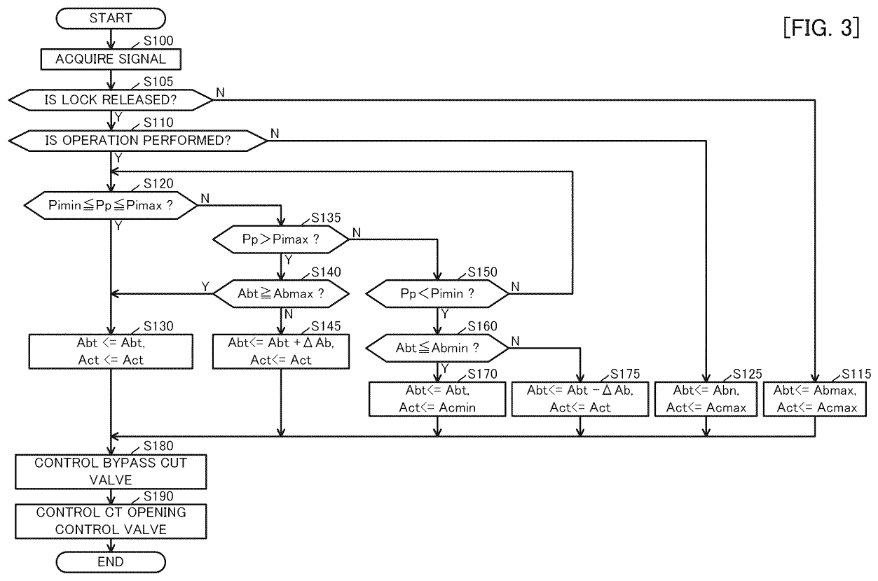

With reference to FIG. 3, an example of a flow of processing of valve control executed by the main controller 100 will be described. The processing depicted in the flowchart of FIG. 3 is started when an ignition switch (not illustrated) is turned on, and is repeatedly executed at a predetermined control cycle.

As depicted in FIG. 3, in Step S100, the main controller 100 acquires the gate lock lever signal from the gate lock lever device 22, the operation signals from the operation devices 23 and 24, and the pressure signal from the pressure sensor 25, and advances the processing to Step S105.

In Step S105, the main controller 100 determines whether the gate lock lever device 22 is operated to the lock release position (lowered position) on the basis of the gate lock lever signal acquired in Step S100. In Step S105, if it is determined that the gate lock lever device 22 is operated to the lock release position (that is, a state in which the actuator can be moved), the processing proceeds to Step S110. In Step S105, if it is determined that the gate lock lever device 22 is operated to the lock position (raised position) (that is, a state in which the actuator cannot be moved), the processing proceeds to Step S115.

In Step S115, the main controller 100 sets a target opening area Abt of the bypass cut valve 17 to the maximum opening area Abmax, and sets target opening areas Act of the CT opening control valves 26A and 26B to a maximum opening area Acmax, and advances the processing to Step S180.

In Step S110, the main controller 100 determines whether at least one of the operation devices 23 and 24 is being operated on the basis of the operation signals acquired in Step S100. Where the operation amounts of the operation devices 23 and 24 are equal to or larger than a predetermined value, the main controller 100 determines that the operation devices 23 and 24 are being operated. Where the operation amounts of the operation devices 23 and 24 are smaller than the predetermined value, the main controller 100 determines that the operation devices 23 and 24 are not being operated. If it is determined in Step S110 that at least one of the operation devices 23 and 24 is being operated, the processing proceeds to Step S120. If it is determined in Step S110 that none of the operation devices 23 and 24 is being operated, the processing proceeds to Step S125.

In Step S125, the main controller 100 sets an opening area during non-operation Abn to the target opening area Abt of the bypass cut valve 17, and sets the maximum opening area Acmax to the target opening areas Act of the CT opening control valves 26A and 26B. Here, the opening area during non-operation Abn is a value larger than the minimum opening area Abmin and smaller than the maximum opening area Abmax (Abmin<Abn<Abmax). The opening area during non-operation Abn is set so as to be capable of generating the pilot primary pressure that can displace the spools of the control valves 45 and 46 to the maximum stroke even if a slight pressure drop occurs. For example, in a case where the pilot primary pressure that can displace the spool to the maximum stroke is 3.0 [MPa], the opening area during non-operation Abn is set to an opening area capable of generating the pilot primary pressure of 3.3 [MPa] as the lower limit pressure Pimin of the pilot primary pressure.

The opening area during non-operation Abn may be an opening area capable of generating the pilot primary pressure within a certain range in which the spool can be displaced to the maximum stroke (the lower limit pressure Pimin or more and the upper limit pressure Pimax or less). In the present embodiment, in a state where the gate lock lever device 22 is operated to the lock release position and the operation devices 23 and 24 are not being operated (standby state), the opening area during non-operation Abn is set such that a pump delivery pressure Pp becomes the upper limit pressure Pimax (for example, approximately 4 MPa) of the pilot primary pressure.

It should be noted that the main controller 100 may sense the pump delivery flow rate that fluctuates depending on the temperature of the hydraulic operating fluid and the engine revolution speed, and may compute the opening area during non-operation Abn such that the delivery pressure of the hydraulic pump 81 sensed by the pressure sensor 25 falls within the certain range (the lower limit pressure Pimin or more and the upper limit pressure Pimax or less).

In Step S120, the main controller 100 determines whether the pump delivery pressure Pp falls within the certain range (the lower limit pressure Pimin or more and the upper limit pressure Pimax or less) on the basis of the pressure signal acquired in Step S100. Where it is determined in Step S120 that the pump delivery pressure Pp falls within the certain range, the processing proceeds to Step S130. Where it is determined in Step S120 that the pump delivery pressure Pp does not fall within the certain range, the processing proceeds to Step S135.

In Step S130, the main controller 100 sets the target opening area Abt set one control cycle before (previous value) to the target opening area Abt of the bypass cut valve 17, sets the target opening area Act set one control cycle before (previous value) to the target opening areas Act of the CT opening control valves 26A and 26B, and advances the processing to Step S180.

In Step S135, the main controller 100 determines whether the pump delivery pressure Pp is higher than the upper limit pressure Pimax on the basis of the pressure signal acquired in Step S100. Where it is determined in Step S135 that the pump delivery pressure Pp is higher than the upper limit pressure Pimax, the processing proceeds to Step S140. Where it is determined in Step S135 that the pump delivery pressure Pp is equal to or lower than the upper limit pressure Pimax, the processing proceeds to Step S150.

In Step S140, the main controller 100 determines whether the target opening area Abt of the bypass cut valve 17 is equal to or larger than the maximum opening area Abmax. Where it is determined in Step S140 that the target opening area Abt of the bypass cut valve 17 is equal to or larger than the maximum opening area Abmax, the processing proceeds to Step S130. Where it is determined in Step S140 that the target opening area Abt of the bypass cut valve 17 is smaller than the maximum opening area Abmax, the processing proceeds to Step S145.

In Step S145, the main controller 100 sets a value obtained by adding a predetermined value ΔAb to the target opening area Abt (previous value) of the bypass cut valve 17 as a new target opening area Abt (current value). In addition, the main controller 100 sets the target opening area Act set one control cycle before (previous value) to the target opening areas Act of the CT opening control valves 26A and 26B, and advances the processing to Step S180.

In Step S150, the main controller 100 determines whether the pump delivery pressure Pp is lower than the lower limit pressure Pimin on the basis of the pressure signal acquired in Step S100. Where it is determined in Step S150 that the pump delivery pressure Pp is lower than the lower limit pressure Pimin, the processing proceeds to Step S160. Where it is determined in Step S150 that the pump delivery pressure Pp is equal to or higher than the lower limit pressure Pimin, the processing returns to Step S120.

In Step S160, the main controller 100 determines whether the target opening area Abt of the bypass cut valve 17 is equal to or smaller than the minimum opening area Abmin. Where it is determined in Step S160 that the target opening area Abt of the bypass cut valve 17 is equal to or smaller than the minimum opening area Abmin, the processing proceeds to Step S170. Where it is determined in Step S160 that the target opening area Abt of the bypass cut valve 17 is larger than the minimum opening area Abmin, the processing proceeds to Step S175.

In Step S170, the main controller 100 sets a minimum opening area (for example, 0) Acmin to the target opening areas Act of the CT opening control valves 26A and 26B. In addition, the main controller 100 sets the target opening area Abt set one control cycle before (previous value) to the target opening area Abt of the bypass cut valve 17, and advances the processing to Step S180.

In Step S175, the main controller 100 sets a value obtained by subtracting the predetermined value ΔAb from the target opening area Abt (previous value) of the bypass cut valve 17 as a new target opening area Abt (current value). In addition, the main controller 100 sets the target opening area Act set one control cycle before (previous value) to the target opening areas Act of the CT opening control valves 26A and 26B, and advances the processing to Step S180.

In Step S180, the main controller 100 outputs a control current according to the target opening area Abt of the bypass cut valve 17 to the solenoid valve 63, and advances the processing to Step S190. In Step S190, the main controller 100 outputs control currents according to the target opening areas Act of the CT opening control valves 26A and 26B to the solenoid valves 61A and 61B, and terminates the processing depicted in the flowchart of FIG. 3.

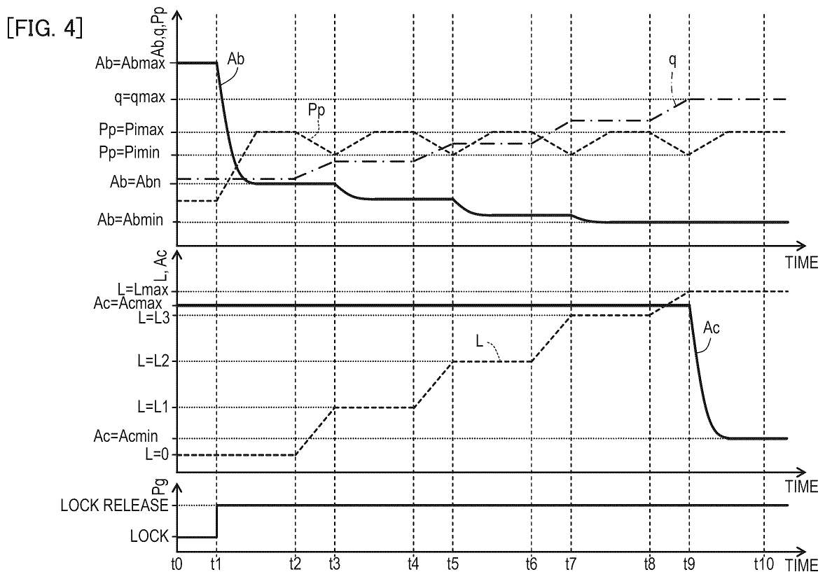

With reference to FIG. 4, the main operation of the hydraulic system 90 in a case where the boom lowering operation is performed will be described. FIG. 4 is a diagram for depicting time-series changes in the operation position Pg of the gate lock lever device 22, the boom lowering operation amount L of the boom operation device 23, the delivery pressure Pp of the hydraulic pump 81, the delivery capacity (the tilting angle of the swash plate) q of the hydraulic pump 81, the opening area Ab of the bypass cut valve 17, and the opening area Ac of the meter-out restrictor 28A of the CT opening control valve 26A. In FIG. 4, the horizontal axis indicates time (elapsed time). At time t0, the gate lock lever device 22 is in the lock position and the bucket 13 is sufficiently far from the ground. At time t1, the operator operates the gate lock lever device 22 to the lock release position. Accordingly, the work device 10 becomes a state in which it can be operated by the operation devices 23 and 24 (standby state). The opening area of the bypass cut valve 17 becomes small from the maximum opening area Abmax to the opening area during non-operation Abn (see Step S125 in FIG. 3). As the opening area of the bypass cut valve 17 decreases, the delivery pressure Pp of the hydraulic pump 81 increases to the upper limit pressure Pimax. Accordingly, the necessary pilot primary pressure is secured, and when the operation devices 23 and 24 are operated, the solenoid valves 61A, 61B, 62A, and 62B can appropriately generate the pilot secondary pressure according to the operation amount.

From time t2, the operator performs the boom lowering operation with the boom operation device 23. From time t2 to time t3, the operation amount L of the boom operation device 23 gradually increases. From time t3 to time t4, the operation amount L is held at an operation amount L1 for fine operation. As the operation amount L increases from time t2, the delivery capacity q of the hydraulic pump 81 increases. The spool of the boom control valve 45 is displaced to a position according to the operation amount L, and the boom 11 is lowered. As the operation amount L of the boom lowering operation increases, the delivery pressure Pp of the hydraulic pump 81 is lowered.

When the delivery pressure Pp of the hydraulic pump 81 is lowered to the lower limit pressure Pimin at time t3, the opening area Ab of the bypass cut valve 17 is reduced by the predetermined value ΔAb (see Step S175 in FIG. 3). Accordingly, the delivery pressure Pp of the hydraulic pump 81 rises to the upper limit pressure Pimax.

From time t4 to time t5, the operation amount L of the boom operation device 23 gradually increases. From time t5 to time t6, the operation amount L is held at an operation amount L2 for half operation. As the operation amount L increases from time t4, the delivery capacity q of the hydraulic pump 81 increases. The spool of the boom control valve 45 is displaced to a position according to the operation amount L, and the lowering speed of the boom 11 increases. As the operation amount L of the boom lowering operation increases, the delivery pressure Pp of the hydraulic pump 81 is lowered.

When the delivery pressure Pp of the hydraulic pump 81 is lowered to the lower limit pressure Pimin at time t5, the opening area Ab of the bypass cut valve 17 is reduced by the predetermined value ΔAb (see Step S175 in FIG. 3). Accordingly, the delivery pressure Pp of the hydraulic pump 81 rises to the upper limit pressure Pimax.

From time t6 to time t7, the operation amount L of the boom operation device 23 gradually increases. From time t7 to time t8, the operation amount L is held at an operation amount L3 between the half operation and the full operation. As the operation amount L increases from time t6, the delivery capacity q of the hydraulic pump 81 increases. The spool of the boom control valve 45 is displaced to a position according to the operation amount L, and the lowering speed of the boom 11 increases. As the operation amount L of the boom lowering operation increases, the delivery pressure Pp of the hydraulic pump 81 is lowered.

When the delivery pressure Pp of the hydraulic pump 81 is lowered to the lower limit pressure Pimin at time t7, the opening area Ab of the bypass cut valve 17 becomes small to the minimum opening area Abmin (for example, 0) of the bypass cut valve 17 (see Step S175 in FIG. 3). Accordingly, the delivery pressure Pp of the hydraulic pump 81 rises to the upper limit pressure Pimax.

From time t8 to time t9, the operation amount L of the boom operation device 23 gradually increases. From time t9 to time t10, the operation amount L is held at a maximum operation amount Lmax for full operation. As the operation amount L increases to the maximum operation amount Lmax from time t8, the delivery capacity q of the hydraulic pump 81 increases to a maximum delivery capacity (maximum tilting angle) qmax. The spool of the boom control valve 45 is displaced to the maximum stroke position, and the lowering speed of the boom 11 increases. As the operation amount L of the boom lowering operation increases, the delivery pressure Pp of the hydraulic pump 81 is lowered.

When the delivery pressure Pp of the hydraulic pump 81 is lowered to the lower limit pressure Pimin at time t9, the opening area Ac of the CT opening control valve 26A becomes small from the maximum opening area Acmax to the minimum opening area Acmin (for example, 0) (see Step S170 in FIG. 3). Accordingly, the delivery pressure Pp of the hydraulic pump 81 rises to the upper limit pressure Pimax.

As described above, in the present embodiment, in a case where the boom lowering operation is performed when the bucket 13 is sufficiently far from the ground, for example, when the operation amount L is lower than the operation amount L3, the opening area of the bypass cut valve 17 becomes small, thereby raising the delivery pressure Pp of the hydraulic pump 81 and preventing the delivery pressure Pp from being lower than the lower limit pressure Pimin of the setting pressure of the pilot pressure reducing valve 71. Further, where the boom lowering operation is performed, for example, when the operation amount L is the maximum operation amount Lmax, the opening areas of not only the bypass cut valve 17 but also the meter-out restrictor 28 of the CT opening control valve 26A become small. Accordingly, the flow rate of the hydraulic operating fluid discharged from the bottom chamber of the boom cylinder 11a and regenerated and supplied to the rod chamber (regeneration flow rate) increases. That is, a sufficient flow rate can be secured on the meter-in side without consuming the delivery flow rate of the hydraulic pump 81 as much as possible. As a result, the delivery pressure Pp of the hydraulic pump 81 (circuit pressure on the meter-in side) rises, and the delivery pressure Pp is prevented from being lower than the setting pressure of the pilot pressure reducing valve 71. That is, according to the present embodiment, where the boom lowering operation is performed when the bucket 13 is far from the ground, a stable pilot primary pressure can be secured, and as a result, a decrease in the cylinder speed can be prevented.

It should be noted that although the operations of the bypass cut valve 17 and the CT opening control valve 26A in a case where the boom lowering operation is performed has been described, the operations of the bypass cut valve 17 and the CT opening control valve 26B when the arm crowding operation is performed are also similar.

According to the above-described first embodiment, the following working effects are exhibited.
(1) The main controller (controller) 100 controls the solenoid valve (third pressure reducing valve) 63 such that the opening area Ab of the bypass cut valve 17 becomes small, when the pressure sensed by the pressure sensor 25 (delivery pressure Pp) is lower than the lower limit pressure (first pressure) Pimin and the opening area Ab of the bypass cut valve 17 is larger than the minimum opening area (first area) Abmin (see Steps S150, S160, S175, and S180 in FIG. 3). That is, the main controller 100 controls the solenoid valve (third pressure reducing valve) 63 such that the opening area Ab of the bypass cut valve 17 becomes small, when the pressure Pp sensed by the pressure sensor 25 becomes low. Accordingly, where the delivery pressure of the hydraulic pump 81 is lowered due to the work device 10 operating in the gravity direction by the boom lowering operation or the arm crowding operation, the bypass cut valve 17 is controlled to the closed side, and the delivery pressure of the hydraulic pump 81 rises. In addition, the main controller 100 controls the solenoid valve 63 such that the opening area Ab of the bypass cut valve 17 becomes large, when the pressure Pp sensed by the pressure sensor 25 is higher than the upper limit pressure (second pressure) Pimax that is higher than the lower limit pressure Pimin and the opening area Ab of the bypass cut valve 17 is smaller than the maximum opening area (second area) Abmax that is larger than the minimum opening area Abmin (see Steps S135, S140, S145, and S180 in FIG. 3). Accordingly, where the delivery pressure of the hydraulic pump 81 rises, the bypass cut valve 17 is controlled to the open side, and the delivery pressure of the hydraulic pump 81 is lowered. As described above, in the present embodiment, since feedback control is performed on the basis of the delivery pressure Pp of the hydraulic pump 81, the delivery pressure Pp of the hydraulic pump 81 can be maintained within the certain range (the lower limit pressure Pimin or more and the upper limit pressure Pimax or less) regardless of the flow rate of the hydraulic operating fluid and the temperature of the hydraulic operating fluid.

Here, as described above, where the weight and the position of the center of gravity of the work device 10 are changed by, for example, replacing the bucket 13 attached to the tip end of the work device 10 with a heavier one, when an operation of causing the work device 10 to operate in the gravity direction is performed, there is a risk that the delivery pressure of the hydraulic pump 81 becomes lower than the pilot primary pressure only by controlling the opening of the bypass cut valve 17.

The main controller 100 according to the present embodiment controls the solenoid valves (fourth pressure reducing valves) 35A and 35B such that the opening areas of the meter-out restrictors 28A and 28B become small, when the pressure Pp sensed by the pressure sensor 25 is lower than the lower limit pressure Pimin and the opening area Ab of the bypass cut valve 17 is equal to or smaller than the minimum opening area (see Steps S150, S160, S170, and S190 in FIG. 3). That is, the hydraulic system 90 according to the present embodiment is configured such that the opening areas of the meter-out restrictors 28A and 28B are reduced as the operation amount of the operation of causing the work device 10 to operate in the gravity direction (the boom lowering operation or the arm crowding operation) by the operation devices 23 and 24 becomes larger.

According to this configuration, where the specification of the work device 10 is changed and the moment of inertia of the work device 10 increases, when an operation of causing the work device 10 to operate in the gravity direction is performed, not only the opening area of the bypass cut valve 17 but also the opening areas of the meter-out restrictors 28A and 28B become small, and the hydraulic operating fluid of the flow rate necessary to maintain the speeds of the hydraulic cylinders 11a and 12a is regenerated and supplied to the hydraulic cylinder through the regeneration passage. Thus, according to the present embodiment, where an operation of causing the work device 10 to operate in the gravity direction, a stable pilot primary pressure can be secured, and as a result, a decrease in the cylinder speed can be prevented.
(2) The main controller 100 controls the solenoid valve 63 such that the opening area Ab of the bypass cut valve 17 becomes an opening area smaller by the predetermined value ΔAb, when a condition that the pressure Pp sensed by the pressure sensor 25 is lower than the lower limit pressure Pimin and the opening area Ab of the bypass cut valve 17 is larger than the minimum opening area Abmin is satisfied (Yes in Step S150 and No in Step S160 in FIG. 3) (see Steps S175 and S180 in FIG. 3). The main controller 100 reduces the opening area Ab of the bypass cut valve 17 stepwise by controlling the solenoid valve 63 every time the above condition is satisfied (see FIG. 4). Accordingly, the sudden pressure fluctuation of the main circuit HC1 can be suppressed.

### Second Embodiment

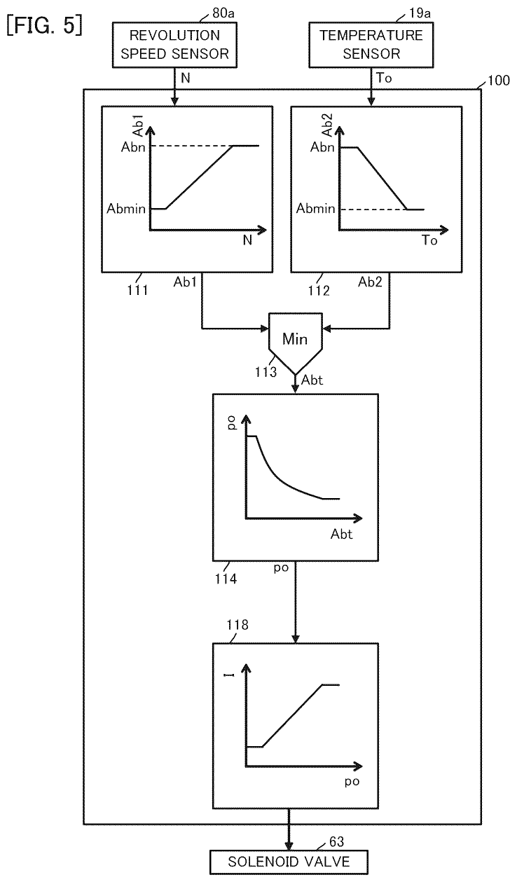

A main controller 100 for controlling a hydraulic excavator 1 according to a second embodiment of the present invention will be described with reference to FIG. 5. It should be noted that the same or equivalent configurations as those described in the first embodiment are denoted by the same reference numerals, and differences are mainly explained. FIG. 5 is a functional block diagram of the main controller 100 according to the second embodiment of the present invention and depicts a function related to the control of the bypass cut valve 17.

In the first embodiment, an example in which the main controller 100 executes feedback control based on the delivery pressure Pp of the hydraulic pump 81 has been described. The main controller 100 according to the first embodiment raises the delivery pressure Pp by reducing the opening area of the bypass cut valve 17 when the delivery pressure Pp becomes lower than the lower limit pressure Pimin, and decreases the delivery pressure Pp by increasing the opening area of the bypass cut valve 17 when the delivery pressure Pp becomes higher than the upper limit pressure Pimax.

The main controller 100 according to the second embodiment has the functions described in the first embodiment, and further has a function of controlling the opening area of the bypass cut valve 17 such that the delivery pressure Pp falls within the certain range (the lower limit pressure Pimin or more and the upper limit pressure Pimax or less) on the basis of the revolution speed of the hydraulic pump 81 and the temperature of the hydraulic operating fluid. The control method (control mode) for the bypass cut valve 17 described in the first embodiment and a control method (control mode) for the bypass cut valve 17 to be described in the second embodiment can be switched to each other by, for example, performing a mode switching operation on an input device in the operation room 31 by the operator.

The main controller 100 according to the second embodiment controls the opening area of the bypass cut valve 17 in consideration of the influence of a flow rate change caused by a change in the revolution speed of the hydraulic pump 81 and the influence of a viscosity change caused by a change in the temperature of the hydraulic operating fluid. For example, when the revolution speed of the hydraulic pump 81 becomes large in a state where the opening area of the bypass cut valve 17 is held at a predetermined area, the flow rate of the hydraulic operating fluid passing through the bypass cut valve 17 becomes large, and the delivery pressure of the hydraulic pump 81 becomes high. Thus, where the delivery pressure becomes the target pressure (for example, 4 [MPa] ) when the opening area of the bypass cut valve 17 is held at a predetermined area and when the revolution speed of the hydraulic pump 81 is a predetermined speed, the opening area of the bypass cut valve 17 needs to be made larger than the predetermined area if the revolution speed of the hydraulic pump 81 becomes larger than the predetermined speed. As similar to the above, where the delivery pressure becomes the target pressure (for example, 4 [MPa] ) when the opening area of the bypass cut valve 17 is held at a predetermined area and when the temperature of the hydraulic operating fluid is a predetermined temperature, the opening area of the bypass cut valve 17 needs to be made larger than the predetermined area if the temperature of the hydraulic operating fluid becomes lower than the predetermined temperature.

Therefore, it is preferable that such characteristics of the opening area of the bypass cut valve 17 relative to the revolution speed of the hydraulic pump 81 and such characteristics of the opening area of the bypass cut valve 17 relative to the temperature of the hydraulic operating fluid that the delivery pressure becomes the target pressure are stored in advance in a nonvolatile memory in the form of a table or a function, and the opening area of the bypass cut valve 17 is controlled by using these characteristics.

As depicted in FIG. 5, the main controller 100 according to the second embodiment has a first target area setting section 111, a second target area setting section 112, a minimum value selection section 113, a proportional valve pressure setting section 114, and a control current setting section 118.

The hydraulic pump 81 is mechanically connected to the engine 80. Therefore, the revolution speed sensor 80a functions as a sensor for sensing the revolution speed of the hydraulic pump 81. It should be noted that the sensor for sensing the revolution speed of the hydraulic pump 81 may be provided separately from the revolution speed sensor 80a of the engine 80. A temperature sensor 19a is provided in the tank 19 or the like (see FIG. 2), senses the temperature of the hydraulic operating fluid, and outputs a signal indicating the sensed result to the main controller 100.

The first target area setting section 111 refers to a speed/opening table and sets a first target area Ab1 of the bypass cut valve 17 on the basis of the revolution speed N of the hydraulic pump 81 sensed by the rotational speed sensor 80a. The speed/opening table is a data table that defines the relation between the revolution speed N of the hydraulic pump 81 and the first target area Ab1, and is stored in a nonvolatile memory. The speed/opening table defines a characteristic in which the first target area Ab1 becomes large from the minimum opening area Abmin to the opening area during non-operation Abn as the revolution speed N of the hydraulic pump 81 increases. Thus, the first target area setting section 111 sets the first target area Ab1 of the bypass cut valve 17 to a larger value as the revolution speed N sensed by the revolution speed sensor 80a is larger. A value of the revolution speed preliminarily set so as to obtain “a pressure that can secure a stable pilot primary pressure” is used for the value of the revolution speed of the speed/opening table.

The second target area setting section 112 refers to a temperature/opening table and sets a second target area Ab2 of the bypass cut valve 17 on the basis of the temperature To of the hydraulic operating fluid sensed by the temperature sensor 19a. The temperature/opening table is a data table that defines the relation between the temperature To of the hydraulic operating fluid and the second target area Ab2, and is stored in a nonvolatile memory. The temperature/opening table defines a characteristic in which the second target area Ab2 becomes small from the opening area during non-operation Abn to the minimum opening area Abmin as the temperature To of the hydraulic operating fluid rises. Thus, the second target area setting section 112 sets the second target area Ab2 of the bypass cut valve 17 to a smaller value as the temperature To sensed by the temperature sensor 19a is higher. A value of the temperature preliminarily set so as to obtain “a pressure that can secure a stable pilot primary pressure” is used for the value of the temperature of the temperature/opening table.

The minimum value selection section 113 selects the smaller one between the first target area Ab1 set by the first target area setting section 111 and the second target area Ab2 set by the second target area setting section 112, and sets the smaller one as the target opening area Abt of the bypass cut valve 17. As described above, the first target area setting section 111, the second target area setting section 112, and the minimum value selection section 113 function as target opening area setting sections for setting the target opening area of the bypass cut valve 17.

The proportional valve pressure setting section 114 refers to an opening/proportional valve pressure table and sets a proportional valve pressure po that is the pilot secondary pressure generated by the solenoid valve 63, on the basis of the target opening area Abt set by the minimum value selection section 113. The opening/proportional valve pressure table is a data table that defines the relation between the target opening area Abt and the proportional valve pressure po, and is stored in a nonvolatile memory. The opening/proportional valve pressure table defines a characteristic in which the proportional valve pressure po becomes smaller as the target opening area Abt becomes larger. Thus, the proportional valve pressure setting section 114 sets the proportional valve pressure po to a smaller value as the target opening area Abt is larger.

The control current setting section 118 sets a control current I output to the solenoid valve 63, on the basis of the proportional valve pressure po set by the proportional valve pressure setting section 114. A data table that defines the relation between the set proportional valve pressure po and the set control current I is stored in a nonvolatile memory as a proportional valve pressure/control current table. The proportional valve pressure/control current table defines a characteristic in which the control current I becomes larger as the proportional valve pressure po becomes larger. Thus, the control current setting section 118 sets the control current I to a larger value as the proportional valve pressure po is larger. The control current setting section 118 outputs the set control current I to the solenoid valve 63.

As described above, the main controller 100 according to the second embodiment sets the first target area Ab1 of the bypass cut valve 17 to a larger value as the revolution speed N of the hydraulic pump 81 sensed by the revolution speed sensor 80a is larger, and sets the second target area Ab2 of the bypass cut valve 17 to a smaller value as the temperature To of the hydraulic operating fluid sensed by the temperature sensor 19a is higher. The main controller 100 selects the smaller one between the first target area Ab1 and the second target area Ab2 and sets the smaller one as the target opening area Abt. The main controller 100 sets the control current I on the basis of the set target opening area Abt, and controls the solenoid valve (third pressure reducing valve) 63 by the set control current I.

According to this configuration, the working effects similar to those in the first embodiment can be exhibited. Further, according to the second embodiment, the risk of hunting due to feedback control can be avoided. In addition, the bypass cut valve 17 can be appropriately controlled according to the revolution speed N of the hydraulic pump 81 and the temperature To of the hydraulic operating fluid. Thus, according to the second embodiment, where an operation of causing the work device 10 to operate in the gravity direction is performed, the pump delivery pressure Pp can be appropriately maintained at a target value Ppt.

The following modified examples are also within the scope of the present invention, and it is possible to combine configurations to be depicted in the modified examples with the configurations described in the above embodiments, to combine the configurations described in the above different embodiments with each other, or to combine configurations to be described in the following different modified examples with each other.

### Modified Example 1

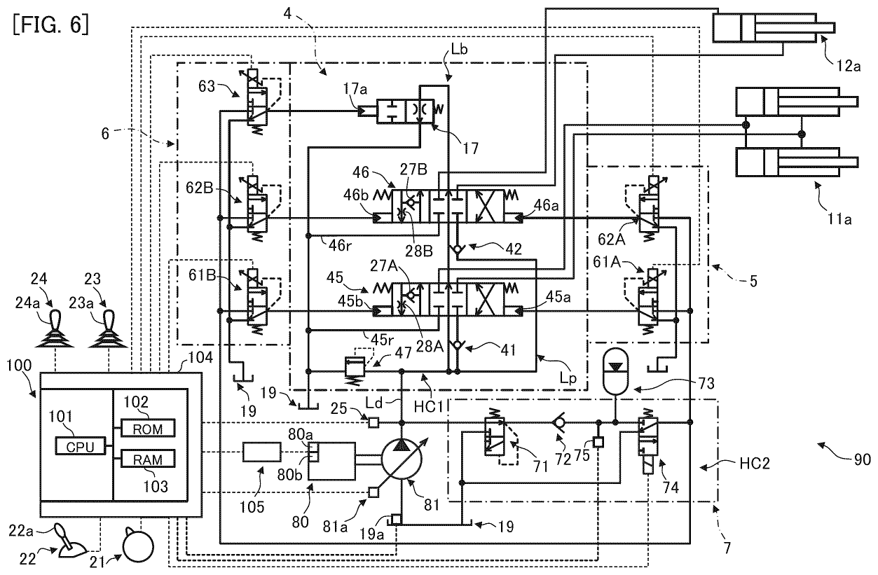

In the above embodiments, an example in which the regeneration passage and the CT opening control valves 26A and 26B having the meter-out restrictors 28A and 28B are provided outside the cylinder control valves 45 and 46 (see FIG. 2) has been described, but the present invention is not limited thereto. As depicted in FIG. 6, the regeneration passage and the meter-out restrictors 28A and 28B may be incorporated into the inside of the cylinder control valves 45 and 46. The meter-out restrictors 28A and 28B are formed such that when the spools of the cylinder control valves 45 and 46 are displaced from the neutral positions, the opening areas thereof become large and then gradually become small according to the displacement of the spools. It should be noted that the hydraulic system 90 according to the present modified example does not include the CT opening control valves 26A and 26B and the solenoid valves 35A and 35B described in the above embodiments.

According to the present modified example, since the opening areas of the meter-out restrictors 28A and 28B are adjusted according to the displacement of the spools of the cylinder control valves 45 and 46, it is possible to obtain the working effects similar to those in the above embodiments. However, in this case, since the opening areas of the meter-out restrictors 28A and 28B change according to the displacement of the spools of the cylinder control valves 45 and 46, the speed of the hydraulic cylinder at the time of fine operation or half operation is affected. In addition, since it is necessary to define the meter-out restrictors 28A and 28B according to the shapes of the spools and holes for accommodating the spools, it takes time and effort to form the cylinder control valves 45 and 46. Therefore, it is preferable that the CT opening control valves 26A and 26B and the cylinder control valves 45 and 46 are provided to be independently controllable as in the above embodiments.

### Modified Example 2

In the above embodiments, an example in which the pressure sensor 25 for sensing the delivery pressure of the hydraulic pump 81 is employed as the pressure sensor for sensing the pressure of the hydraulic operating fluid on the delivery side of the hydraulic pump 81, and the main controller 100 controls the solenoid valve 63 on the basis of the sensed result of the pressure sensor 25 has been described, but the present invention is not limited thereto. The main controller 100 may control the solenoid valve 63 on the basis of the sensed result of the pressure sensor 75 (see FIG. 2 and FIG. 6) for sensing the pressure of the hydraulic operating fluid on the delivery side of the hydraulic pump 81, instead of the sensed result of the pressure sensor 25. The pressure sensor 25 is a pump pressure sensor that is provided on the upstream side of the pilot pressure reducing valve 71 and senses the delivery pressure of the hydraulic pump 81. On the other hand, the pressure sensor 75 is an accumulator pressure sensor that is provided on the downstream side of the pilot pressure reducing valve 71 and senses the pressure of the accumulator 73. By employing a configuration in which the solenoid valve 63 is controlled on the basis of the sensed result of the pressure sensor 75 for sensing the pressure of the accumulator 73, the frequency of squeezing the bypass cut valve 17 can be reduced as compared with the configuration in which the solenoid valve 63 is controlled on the basis of the sensed result of the pressure sensor 25 for sensing the delivery pressure of the hydraulic pump 81.

### Modified Example 3

In the first embodiment, an example in which the CT opening control valve 26A is controlled to be fully closed to prevent the delivery pressure Pp of the hydraulic pump 81 from lowering when the bypass cut valve 17 is fully closed when the boom lowering operation is performed, and the CT opening control valve 26B is controlled to prevent the delivery pressure Pp of the hydraulic pump 81 from lowering when the bypass cut valve 17 is fully closed when the arm crowding operation is performed has been described. However, the present invention is not limited thereto. The control content of the CT opening control valves described in the first embodiment may be applied to only one of the CT opening control valve 26A and the CT opening control valve 26B.

### Modified Example 4

In the above embodiments, an example of a configuration in which the hydraulic operating fluid delivered from the single hydraulic pump 81 is supplied to the boom cylinder 11a through the boom control valve 45 has been described, but the present invention is not limited thereto. The present invention can also be applied to, for example, a configuration in which the hydraulic operating fluid delivered from two or more hydraulic pumps 81 is supplied to the boom cylinder 11a through a plurality of boom control valves 45. In this case, the meter-out restrictor 28A is incorporated into one of the plurality of boom control valves 45 as similar to the second embodiment, the boom control valve 45 provided with the meter-out restrictor 28A is caused to operate as similar to the CT opening control valve 26A described in the first embodiment, and thus the working effects similar to the above first embodiment can be obtained.

### Modified Example 5

In the second embodiment, an example in which the main controller 100 selects the smaller one between the first target area Ab1 set on the basis of the revolution speed N of the hydraulic pump 81 and the second target area Ab2 set on the basis of the temperature To of the hydraulic operating fluid, and sets the smaller one as the target opening area Abt of the bypass cut valve 17 has been described. That is, the main controller 100 according to the second embodiment is configured to set the target opening area Abt in consideration of both the revolution speed N of the hydraulic pump 81 and the temperature To of the hydraulic operating fluid. However, the method of setting the target opening area Abt is not limited to this method.

### Modified Example 5-1

For example, the main controller 100 may control the solenoid valve 63 by setting the target opening area Abt of the bypass cut valve 17 to a larger value as the revolution speed N sensed by the revolution speed sensor 80a is larger. In this configuration, the bypass cut valve 17 can be appropriately controlled according to the revolution speed N of the hydraulic pump 81.

### Modified Example 5-2

In addition, for example, the main controller 100 may control the solenoid valve 63 by setting the target opening area Abt of the bypass cut valve 17 to a smaller value as the temperature To sensed by the temperature sensor 19a is higher. In this configuration, the bypass cut valve 17 can be appropriately controlled according to the temperature To of the hydraulic operating fluid.

### Modified Example 6

In the above embodiments, an example in which the bypass cut valve 17 is provided on the downstream side of the cylinder control valves 45 and 46 in the center bypass passage Lb has been described, but the present invention is not limited thereto. The bypass cut valve 17 may be provided on the upstream side of the cylinder control valves 45 and 46 in the center bypass passage Lb.

Although the embodiments of the present invention have been described above, the above embodiments depict only a part of an application example of the present invention, and it is not intended to limit the technical scope of the present invention to the specific configurations of the above embodiments.

### DESCRIPTION OF REFERENCE CHARACTERS

1: Hydraulic excavator (work machine)
10: Work device
11: Boom (member to be driven)
11a: Boom cylinder (hydraulic cylinder)
12: Arm (member to be driven)
12a: Arm cylinder (hydraulic cylinder)
13: Bucket (member to be driven)
13a: Bucket cylinder (hydraulic cylinder)
17: Bypass cut valve
17a: Pilot pressure receiving section
19: Tank
19a: Temperature sensor
20: Machine body (vehicle body)
22: Gate lock lever device
23: Boom operation device (operation device)
24: Arm operation device (operation device)
25: Pressure sensor
26A, 26B: CT opening control valve (meter-out control valve)
27A, 27B: Check valve
28A, 28B: Meter-out restrictor
35A, 35B: Solenoid valve (fourth pressure reducing valve)
45: Boom control valve (cylinder control valve)
45a, 45b: Pilot pressure receiving section
45r: Return oil line (meter-out passage)
46: Arm control valve (cylinder control valve)
46a, 46b: Pilot pressure receiving section
46r: Return oil line (meter-out passage)
61A, 61B, 62A, 62B: Solenoid valve (second pressure reducing valve)
63: Solenoid valve (third pressure reducing valve)
71: Pilot pressure reducing valve (first pressure reducing valve)
73: Accumulator
74: Lock valve
75: Pressure sensor
80: Engine
80a: Revolution speed sensor
81: Hydraulic pump
81a: Regulator
90: Hydraulic system
100: Main controller (controller)
111: First target area setting section
112: Second target area setting section
113: Minimum value selection section
114: Proportional valve pressure setting section
118: Control current setting section
Ab: Opening area of bypass cut valve
Ab1: First target area
Ab2: Second target area
Abmax: Maximum opening area (second area)
Abmin: Minimum opening area (first area)
Abn: Opening area during non-operation
Abt: Target opening area of bypass cut valve
Ac: Opening area of CT opening control valve
Acmax: Maximum opening area
Acmin: Minimum opening area
Act: Target opening area of CT opening control valve
HC1: Main circuit
HC2: Pilot circuit
I: Control current
L: Operation amount
Lb: Center bypass passage
Ld: Pump delivery passage
Lp: Parallel passage (meter-in passage)
N: Revolution speed of hydraulic pump
Pimax: Upper limit pressure (second pressure)
Pimin: Lower limit pressure (first pressure)
po: Proportional valve pressure
po′: Proportional valve pressure after correction
Pp: Delivery pressure of hydraulic pump (measured value)
Ppt: Target value of pressure of hydraulic operating fluid on delivery side of hydraulic pump
q: Delivery capacity of hydraulic pump
To: Temperature of hydraulic operating fluid
ΔAb: Predetermined value
Δpo: Correction value
ΔPp: Pressure deviation (deviation)

1. A work machine comprising:
a work device that has a plurality of hydraulic cylinders and a plurality of members to be driven by the plurality of hydraulic cylinders;
an operation device for operating the hydraulic cylinders;
a main circuit that supplies a hydraulic operating fluid delivered from a hydraulic pump to the hydraulic cylinders;
a cylinder control valve that is provided in the main circuit and controls a flow of the hydraulic operating fluid supplied from the hydraulic pump to the hydraulic cylinders;
a pilot circuit that introduces a part of the hydraulic operating fluid delivered from the hydraulic pump to a pilot pressure receiving section of the cylinder control valve;
a first pressure reducing valve that is provided in the pilot circuit and reduces a pressure of the hydraulic operating fluid delivered from the hydraulic pump to generate a pilot primary pressure;
a second pressure reducing valve that is provided in the pilot circuit and reduces the pilot primary pressure to generate a pilot secondary pressure acting on the pilot pressure receiving section of the cylinder control valve;
a center bypass passage that connects the hydraulic pump and a tank to each other and is provided with the cylinder control valve;
a bypass cut valve that is provided in the center bypass passage;
a third pressure reducing valve that is provided in the pilot circuit and reduces the pilot primary pressure to generate a pilot secondary pressure acting on a pilot pressure receiving section of the bypass cut valve;
a regeneration passage that connects a meter-in passage for introducing the hydraulic operating fluid delivered from the hydraulic pump to the hydraulic cylinders and a meter-out passage for introducing return oil from the hydraulic cylinders to the tank to each other;
a check valve that is provided in the regeneration passage, permits a flow of the hydraulic operating fluid from the meter-out passage to the meter-in passage, and prohibits a flow of the hydraulic operating fluid from the meter-in passage to the meter-out passage;
a meter-out restrictor that is provided in the meter-out passage;
a pressure sensor that senses the pressure of the hydraulic operating fluid on a delivery side of the hydraulic pump; and
a controller that controls the second pressure reducing valve on a basis of an operation amount of the operation device, wherein
the controller
controls the third pressure reducing valve on a basis of the pressure sensed by the pressure sensor,
controls the third pressure reducing valve such that an opening area of the bypass cut valve becomes small, when the pressure sensed by the pressure sensor becomes low, and
is configured to reduce an opening area of the meter-out restrictor as the operation amount of an operation of causing the work device to operate in a gravity direction by the operation device becomes larger.

2. The work machine according to claim 1, wherein
the work machine includes
a meter-out control valve that has the meter-out restrictor, and
a fourth pressure reducing valve that is provided in the pilot circuit and reduces the pilot primary pressure to generate a pilot secondary pressure acting on a pilot pressure receiving section of the meter-out control valve, and
the controller
controls the third pressure reducing valve such that the opening area of the bypass cut valve becomes small, when the pressure sensed by the pressure sensor is lower than a first pressure and the opening area of the bypass cut valve is larger than a first area,
controls the third pressure reducing valve such that the opening area of the bypass cut valve becomes large, when the pressure sensed by the pressure sensor is higher than a second pressure that is higher than the first pressure and the opening area of the bypass cut valve is smaller than a second area that is larger than the first area, and
controls the fourth pressure reducing valve such that the opening area of the meter-out restrictor becomes small, when the pressure sensed by the pressure sensor is lower than the first pressure and the opening area of the bypass cut valve is equal to or smaller than the first area.

3. The work machine according to claim 2, wherein
the controller
controls the third pressure reducing valve such that the opening area of the bypass cut valve becomes an opening area that is small by only a predetermined value, when a condition that the pressure sensed by the pressure sensor is lower than the first pressure and the opening area of the bypass cut valve is larger than the first area is satisfied, and
is configured to reduce the opening area of the bypass cut valve stepwise by controlling the third pressure reducing valve every time the condition is satisfied.

4. The work machine according to claim 1, wherein
the work machine includes
a revolution speed sensor that senses a revolution speed of the hydraulic pump, and
a temperature sensor that senses a temperature of the hydraulic operating fluid, and
the controller is configured to
set a first target area of the bypass cut valve to be a larger value as the revolution speed sensed by the revolution speed sensor is larger,
set a second target area of the bypass cut valve to be a smaller value as the temperature sensed by the temperature sensor is higher,
select a smaller one between the first target area and the second target area to set the smaller one as a target opening area of the bypass cut valve, and
control the third pressure reducing valve.

5. The work machine according to claim 1, wherein
the work machine includes a revolution speed sensor that Senses a revolution speed of the hydraulic pump, and
the controller is configured to
set a target opening area of the bypass cut valve to be a larger value as the revolution speed sensed by the revolution speed sensor is larger, and
control the third pressure reducing valve.

6. The work machine according to claim 1, wherein
the work machine includes a temperature sensor that senses a temperature of the hydraulic operating fluid, and
the controller is configured to
set a target opening area of the bypass cut valve to be a smaller value as the temperature sensed by the temperature sensor is higher, and
control the third pressure reducing valve.

7. The work machine according to claim 1, wherein
the pressure sensor is provided on a downstream side of the first pressure reducing valve.
